(19) United States
(12) Patent Application Publication
(10) Pub. No.: US 2014/0101257 A1
(43) Pub. Date: Apr. 10, 2014

(54) APPARATUS AND METHOD FOR AUDIO FRAME LOSS RECOVERY

(71) Applicant: GENERAL INSTRUMENT CORPORATION, Horsham, PA (US)

(72) Inventor: James M. Hunter, JR., San Jose, CA (US)

(73) Assignee: GENERAL INSTRUMENT CORPORATION, Horsham, PA (US)

(21) Appl. No.: 13/644,911

(22) Filed: Oct. 4, 2012

(51) Int. Cl. G06F 15/16

(52) U.S. Cl. 709/206

(57) ABSTRACT

In one embodiment, a method includes receiving a message from a user client device associated with a user. The message is generated in response to a code being captured by the user client device. A computer system determines a user identifier for a user associated with the user client device based on the message. Also, the computer system determines a control data set based on the message, the control data set including information used to automatically control a set of controllable devices. Then, the computer system automatically makes the control data set available to allow access by a user network device associated with the user identifier. The user network device is configured to download the control data set to automatically allow controlling of the set of controllable devices when connected to the user network device.

### CROSS REFERENCE TO RELATED APPLICATIONS

The present disclosure is related to U.S. Pat. No. 7,680,745, entitled “Automatic Configuration and Control of Devices using Metadata”, which is incorporated by reference in its entirety for all purposes.

### BACKGROUND

A user may automatically control controllable devices owned by the user in a location, such as the user's home. For example, the user may control the dimming of different lights, the unlocking or locking of doors, the operation of a thermostat that controls a heating, ventilation, and air-conditioning (HVAC) unit, or the turning on/turning off of different appliances. In one example, the user may use a device, such as a mobile device, to automatically control the controllable devices. For example, the user may choose to turn off a light via the user's mobile device.

A user may also program the controllable devices to perform specific actions automatically. For example, a user may program lights to turn on in the evening and also program the heat to turn on in the nighttime. The program would include rules and actions. When events occur, a network device applies the events to the rules to determine any actions to perform. For example, the rules for the program may state when the time equals 6:00 p.m., turn on the lights, and when the time equals 9:00 p.m., turn on the heat. Thus, at 6:00 p.m., the network device would turn on the lights, and at 9:00 p.m., the network device would turn the heat on. Using the programs is convenient because the user does not have to affirmatively control the controllable devices every day at 6:00 p.m. and 9:00 p.m. when the events occur. However, the user does need to program the network device and controllable devices to perform the actions. In some cases, the desired programs may be complicated and thus hard for a user to manually program. Further, programming the network device and controllable devices may be time consuming for the user.

### BRIEF DESCRIPTION OF THE DRAWINGS

FIG. 1 depicts a simplified system for automatically integrating a control data set for controlling controllable devices according to one embodiment.

FIG. 2 depicts a more detailed example of a first location according to one embodiment.

FIG. 3 depicts a more detailed example of a remote server to allow downloading of uploaded control data sets according to one embodiment.

FIG. 4 depicts a more detailed example of a user network device according to one embodiment.

FIGS. 5A and 5B depict a simplified flowchart of a method for automatically configuring controllable devices according to one embodiment.

FIG. 6 depicts an example of a system for using a loyalty program to automatically configure controllable devices according to one embodiment.

### DETAILED DESCRIPTION

In the following description, for purposes of explanation, numerous examples and specific details are set forth in order to provide a thorough understanding of particular embodiments. Particular embodiments as defined by the claims may include some or all of the features in these examples alone or in combination with other features described below, and may further include modifications and equivalents of the features and concepts described herein.

Particular embodiments allow a user to capture a code using a user client device, such as a cellular phone, tablet computer, or other mobile device. The code includes encoded information that is associated with a control data set. For example, the code may be a quick response (QR) code or near field communication (NFC) code that encodes a control data set identifier associated with the control data set. The control data set may include rules, logic, and policies for controlling a set of controllable devices. Upon capturing the code, the user client device decodes the encoded information and sends the control data set identifier and a user identifier to a server. The server then associates the control data set identifier with the control data set. After the control data set is identified, the server uploads the control data set to allow a user network device associated with the user identifier to access the control data set. For example, the user network device may be a gateway or control point associated with the user's home network and the user network device retrieves the control data set from a remote server located in a network. The user network device may install the control data set, which can then be used to automatically control controllable devices connected to the user network device.

In one example, the code may be displayed in a store or magazine. Also, the store or magazine may show a demonstration of a set of controllable devices that are automatically being controlled using the control data set. For example, the store may demonstrate lights that are controlled in a pattern for the holidays. If a user is interested in controlling his/her controllable devices in the same way, the user can capture the code associated with the control data set. Then, by capturing the code, the user is able to have the user network device be automatically programmed to control the user's controllable devices based on the control data set. In this way, if the user sees lights being controlled by a program in a store, the user may capture the code associated with those lights and then automatically have lights programmed in the user's home to perform in the same way.

In one embodiment, a method includes receiving a message from a user client device associated with a user. The message is generated in response to a code being captured by the user client device. A computer system determines a user identifier for a user associated with the user client device based on the message. Also, the computer system determines a control data set based on the message, the control data set including information used to automatically control a set of controllable devices. Then, the computer system automatically makes the control data set available to allow access by a user network device associated with the user identifier. The user network device is configured to download the control data set to automatically allow controlling of the set of controllable devices when connected to the user network device.

In one embodiment, a method captures, by a user client computing device, a code including encoded information for controlling a set of controllable devices; decodes, by the user client computing device, the encoded information from the code; determines a user identifier for a user associated with the user client computing device; generates, by the user client computing device, a message using the decoded information and the user identifier; and sends, by the user client computing device, the message to a server to have a control data set automatically made available to allow access by a user network device associated with the user identifier, wherein the user network device is configured to download the control data set to automatically allow controlling of the set of controllable devices when connected to the user network device.

In one embodiment, a system is provided including a user client computing device configured to: capture a code including encoded information for controlling a set of controllable devices; decode the encoded information from the code; determine a user identifier for a user associated with the user client computing device; generate a message using the decoded information and the user identifier; and send the message. The system also includes a server configured to: store a control data set in association with the user identifier in response to the message; make the control data set automatically available to allow access by a user network device associated with the user identifier in response to the message being sent; and send the control data set to the user network device. The user network device installs the control data set to automatically allow control of the set of controllable devices when connected to the user network device.

Automatic Integration of Control Data Sets to Configure Controllable Devices

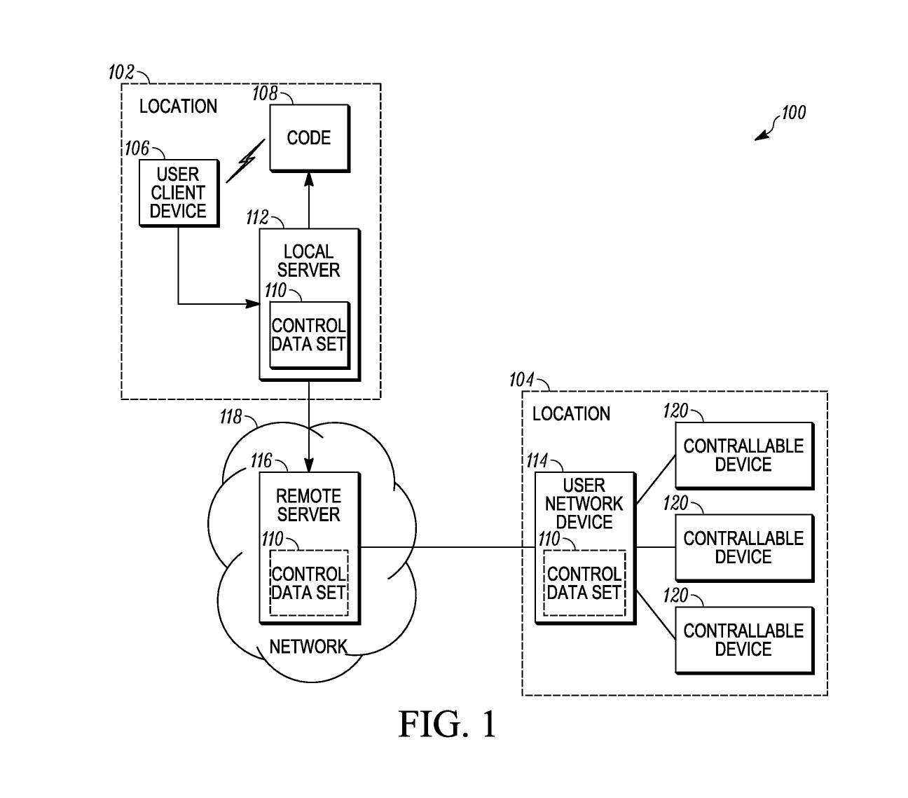

FIG. 1 depicts a simplified system 100 for automatically integrating a control data set for controlling controllable devices 120 according to one embodiment. System 100 includes a first location 102 and a second location 104. In one embodiment, location 102 may be a store and location 104 may be a different location, such as a home or office associated with a user. For example, a user may be shopping in first location 102 and the user's home may be second location 104. First location 102 and second location 104 may also be connected via a network 118, such as a wide area network (WAN). It should be understood that although first location 102 and second location 104 are shown, location 102 and location 104 do not need to be separate locations. Further, locations are used for discussion purposes only. For example, instead of location 102, a magazine, television display, or other medium may be used to display a code 108.

A user may use a user client device 106 to capture a code 108. User client device 106 may be a smartphone, a tablet computer, a network computer, a laptop computer, or other devices capable of capturing code 108.

Code 108 may be a graphical representation, such as a quick response (QR) code or a bar code. In other examples, code 108 may be in electronic form, such as in a near field communication (NFC) code. If a graphical code is being used, the graphical code may be displayed on a computing device, such as a computer monitor, or may be printed on a document, such as on a piece of paper, magazine, book, wall, or other display. If an electronic code is being used, a computing device (e.g., a kiosk) may be provided that can communicate the electronic code to user client device 106.

Code 108 is associated with a control data set 110. Control data set 110 may include information, such as rules, logic, and/or policies, that is used to automatically control controllable devices. In one embodiment, encoded information in code 108 may be associated with control data set 110. In one example, the encoded information may be a control data set identifier for control data set 110. The control data set identifier may be any information that can be used to identify control data set 110, such as a uniform resource locator (URL), unique ID, etc. In other embodiments, the encoded information may be the actual control data set 110. For example, the rules, logic, and/or policies may be encoded in code 108.

In one embodiment, a local server 112 stores control data set 110 and associates control data set 110 with the control data set identifier. Although local server 112 is shown as being in location 102, local server 112 may be located in other locations, such as local server 112 may be a server that user client device 106 connects to through a wide area network (WAN).

When user client device 106 captures code 108, user client device 106 may decode the encoded information in code 108. As discussed above, the decoded information may be a control data set identifier or the control data set. Also, the decoded information may be a link (e.g., a uniform resource locator (URL) that is used to retrieve the control data set identifier). Once determining the decoded information, user client device 106 generates a message to local server 112. For example, user client device 106 may use an application to capture code 108. The application may be a scanning application that controls a scanner to capture code 108. Additionally, the application may identify the user using a user identifier. The user identifier may be an account number, username, or other information that uniquely identifies the user using user client device 106. The application then generates the message using the decoded information and the user identifier, and sends the message to local server 112.

Local server 112 receives the message and associates the message with control data set 110. For example, local server 112 may use the control data set identifier to look up control data set 110. In the case where control data set 110 is included in the encoded information, local server 112 may not need to retrieve any stored information.

Local server 112 then makes control data set 110 available to a user network device 114 that is associated with the user. In one example, local server 112 may upload control data set 110 to a remote server 116 that is located in network 118, which may be an external network of devices that can be accessed by user network devices 114. When remote server 116 receives control data set 110, remote server 116 may store control data set 110 in association with the user identifier. Although remote server 116 and local server 112 are described, it will be understood that the functions of both remote server 116 and local server 112 may be performed by a single server or distributed in multiple servers. However, in one embodiment, remote server 116 is used such that user network devices 114 do not access a local network for a company.

Once control data set 110 has been made available, user network device 114 can download control data set 110. In one example, user network device 114 is configured to periodically communicate with remote server 116 to check if any updates are available. In this case, remote server 116 responds to any requests from user network device 114 with an indication that control data set 110 is available for download. User network device 114 then downloads control data set 110. In other embodiments, remote server 116 may push control data set 110 to user network device 114.

User network device 114 then can install control data set 110 locally. When control data set 110 is installed, controllable devices 120 that are coupled to user network device 114 may be automatically controlled based on control data set 110. For example, controllable devices 120 may be connected to user network device 114 via a local area network (LAN). By installing control data set 110, user network device 114 automatically controls controllable devices 120 per the rules, logic, and/or policies in control data set 110. For example, user network device 114 controls lights to turn on and off via a rules set in control data set 110. In other embodiments, user network device 114 may control a home HVAC system via a policy to reduce energy costs.

Accordingly, a user may be browsing in a store and see controllable devices that are set up in the store and programmed based certain rules or policies. For example, lights may be controlled to perform a routine in a pattern for the holidays. Also, a QR code may be displayed next to the lights. The user may decide that the user would like his/her lights in his/her home to perform in the same way. The user then uses user client device 106 to scan the QR code that is displayed next to the lights. Upon scanning, the user's lights in the user's home are automatically programmed to perform the routine that is the same as routine the lights are performing in the store. This allows a user to automatically program controllable devices 120 in a user's home based on scanning the QR code.

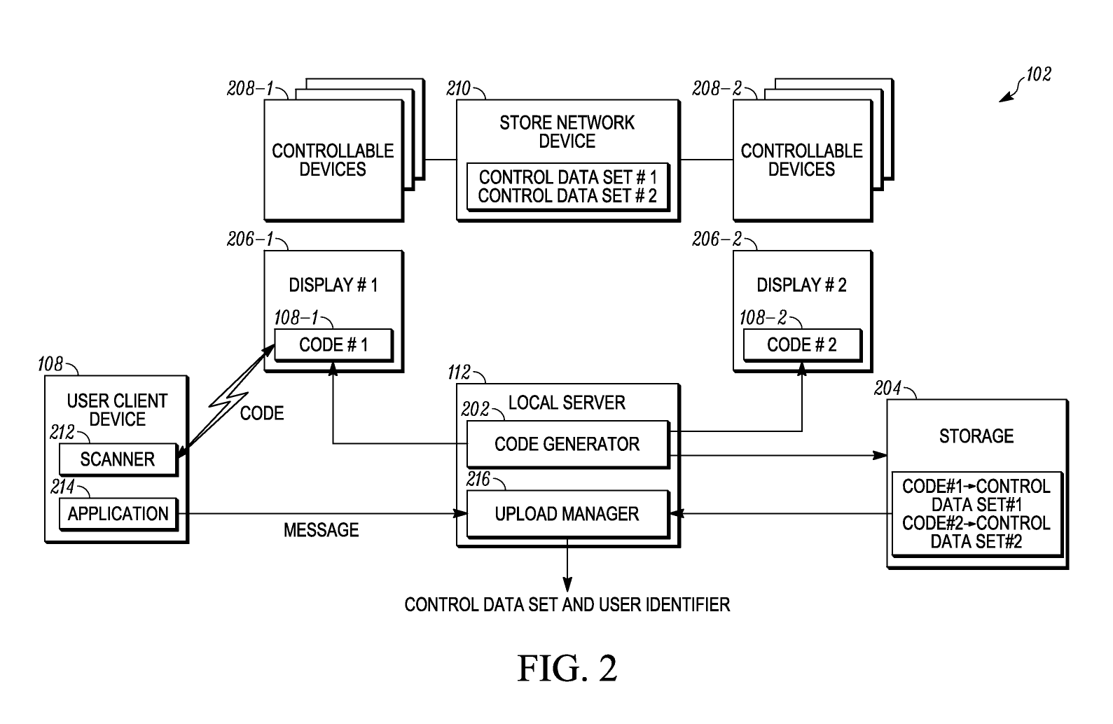

FIG. 2 depicts a more detailed example of location 102 according to one embodiment. A code generator 202 generates codes 108 based on different control data sets 110. For example, code generator 202 generates a first code (code #1) 108-1 that includes a first control data set identifier for a first control data set (control data set #1) 110-1 and generates a second code (code #2) 108-2 that includes a second control data set identifier for a second control data set (control data set #2) 110-2. In one embodiment, code generator 202 may use any encoding algorithm to generate codes 108-1 and 108-2. Code generator 202 may then store an association of the control data set identifiers and control data sets 110 in storage 204. Although code generator 202 is shown as being part of local server 112, code generator 202 may be included in a different device.

Code generator 202 then outputs code 108-1 and code 108-2 to a first display (display #1) 206-1 and a second display (display #2) 206-2, respectively. Displays 206-1 and 206-2 may be monitors that can display codes 108. In other embodiments, codes 108-1 and 108-2 may be output on printed material or another medium.

In one embodiment, display 206-1 is displayed near a set of controllable devices 208-1 and display #2 is displayed near a set of controllable devices 208-2. Controllable devices 208-1 are controlled based on control data set 110-1. For example, a store network device 210 may control controllable devices 208-1 using control data set 110-1. Similarly, store network device 210 may control controllable devices 208-2 based on control data set 110-2. Although controllable devices 208-1 and 208-2 are described as being physically demonstrated in the store, it will be understood that particular embodiments do not need to have controllable devices 208-1 and 208-2 physically displayed. Rather, users may be browsing a magazine or web site and see an image or description of the controllable devices or the control data set along with code 108-1 and/or code 108-2. Further, the web site may have a window that shows a video feed of actual controllable devices that can be controlled via the web site.

As a user is browsing in location 102 and sees controllable devices 208-1 or 208-2 being controlled based on the respective control data sets 110-1 and 110-2, a user may decide that the user wants to control his/her own controllable devices 120 in the same way. In one example, the user may use a scanner 212 of user client device 106 to capture code 108-1. An application 214 receives code 108-1 and can decode the encoded information in code 108-1. Also, application 214 may determine a user identifier that uniquely identifies the user. For example, the user may have logged into application 214 using credentials that provided the user identifier. In other examples, application 214 may prompt the user to enter in the user identifier. Application 214 may then generate a message using the decoded information and the user identifier. Once generated, application 214 sends the message to an upload manager 216 of local server 112.

Upload manager 216 uses the decoded information to determine control data set 110-1. For example, upload manager 216 uses the control data set identifier in the decoded information to retrieve control data set 110-1 from storage 204. In other examples, control data set 110-1 may have been encoded in code 108-1 and thus upload manager 216 does not need to retrieve control data set 110-1 from storage 204. Once control data set 110-1 is determined, upload manager 216 makes control data set 110-1 available. For example, upload manager 216 may upload control data set 110-1 to remote server 116.

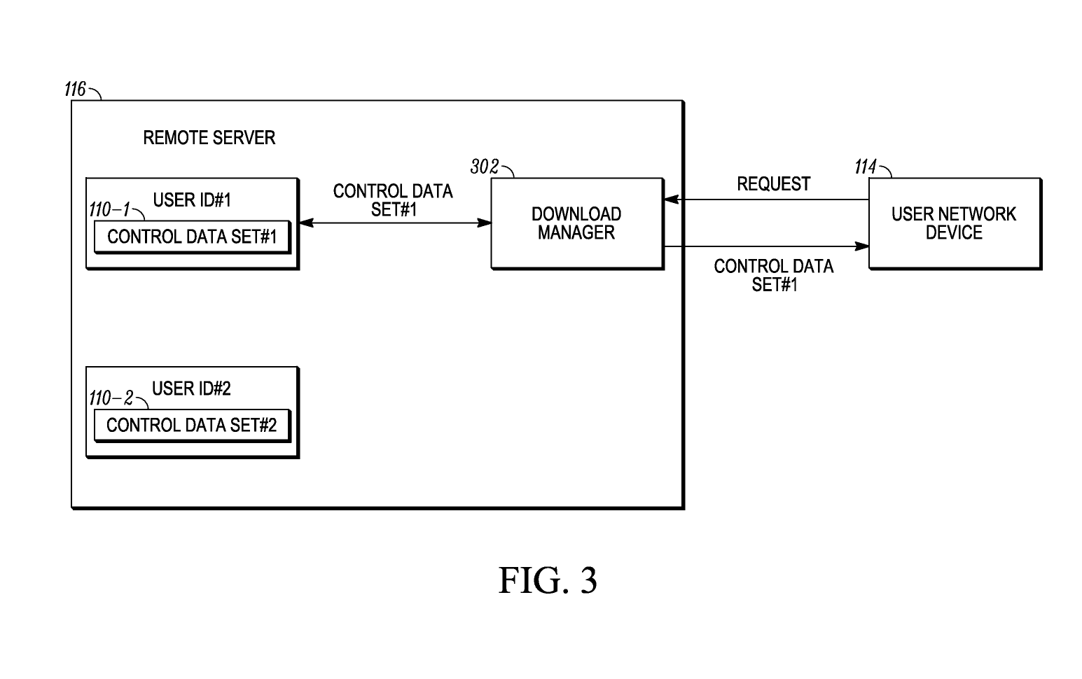

FIG. 3 depicts a more detailed example of remote server 116 to allow downloading of uploaded control data sets 110 according to one embodiment. A download manager 302 receives control data sets 110 and associates the control data sets 110 with user identifiers. For example, download manager 302 receives control data set 110-1 and stores the control data set 110-1 in association with a user ID #1. Additionally, other control data sets 110 may have been received and are associated with other user identifiers, such as a control data set (control data set #2) 110-2 has been associated with a user ID #2.

Download manager 302 receives requests from various user network devices 114. For example, download manager 302 receives a request from a user network device 114 that is associated with user ID #1. Download manager 302 then determines that a new control data set 110-1 has been made available for the user associated with user ID #1. Download manager 302 retrieves control data set 110-1 and sends control data set 110-1 to user network device 114. Download manager 302 may also process other requests for other users to retrieve control data sets 110. Thus, download manager 302 may restrict users to only download authorized control data sets 110.

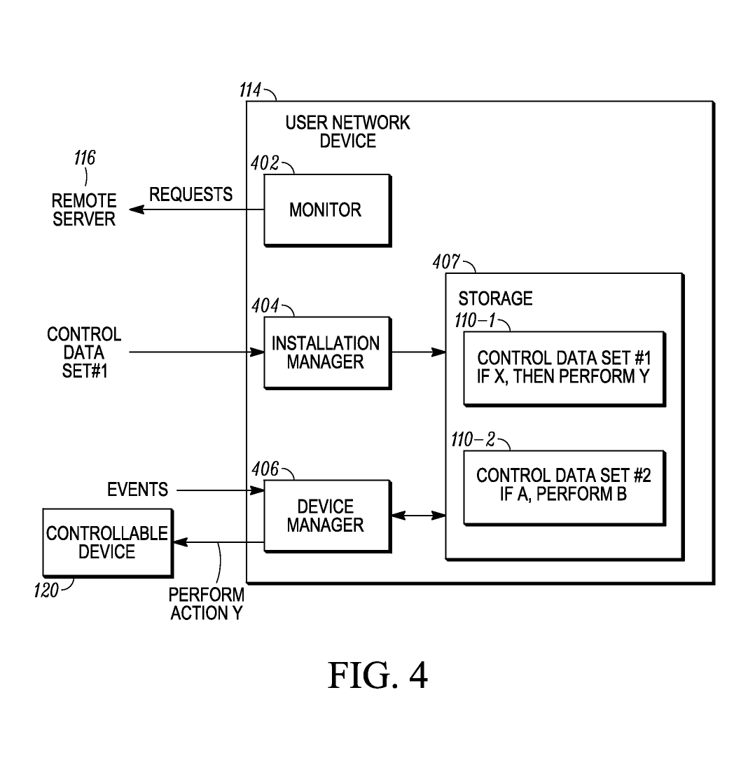

Once receiving control data set 110-1, user network device 114 can install control data set 110-1. FIG. 4 depicts a more detailed example of user network device 114 according to one embodiment. As discussed above, user network device 114 may send requests for control data sets 110 that are available for download. In one example, a monitor 402 periodically sends requests for control data sets 110, such as every day. In other examples, monitor 402 may be triggered to send a request, such as when a new device is installed or a user requests that monitor 402 send a request.

An installation manager 404 receives control data set 110-1 and installs control data set 110-1. For example, installation manager 404 may install control data set 110-1 with other previously downloaded and/or configured control data sets 110 in storage 407. For example, user network device 114 may send control data set 110-1 to control points (not shown) that are configured to control controllable devices 120. For discussion purposes, it will be assumed that user network device 114 will be described as controlling controllable devices 120; however, it will be understood that user network device 114 may be a distributed network of devices that can control different controllable devices 120.

A device manager 406 controls controllable devices 120 according to control data sets 110 that are stored in storage 407. For example, control data sets 110 include rules and actions to perform. As shown, control data set 110-1 states that if event X occurs, action Y should be performed. When an event occurs at controllable device 120, device manager 406 receives the event and determines if the event triggers any action. For example, if event X occurs, device manager 406 determines that control data set 110-1 includes a rule associated with event X. In this case, the rule states that an action Y should be performed when event X occurs. Accordingly, device manager 406 performs action Y with controllable device 120. Although event X and action Y were described as being performed with a same controllable device 120, it will be understood that events and actions may be associated with different controllable devices 120. For example, a door may be unlocked and then a light may be turned on. Also, although this rule has been described, other logic and policies may be performed. For example, control data set 110-1 may program controllable devices 120 to perform certain actions based on a policy. That is, the lights may turn on and off in a holiday light pattern. Additionally, control data set 110-1 may be a metatag that classifies controllable devices 120. The metatag may include rules that are configured. When controllable devices are associated with the metatag, these controllable devices 120 are automatically configured to be controlled based on the rules associated with the metatag. For example, a metatag may be “hallway lights” and any light classified as a hallway light will be controlled based on hallway light rules. In one example, U.S. Pat. No. 7,680,745 entitled “Automatic Configuration and Control of Devices using Metadata”, which is incorporated by reference in its entirety for all purposes, describes metatags in more detail.

Accordingly, user network device 114 automatically configures controllable devices 120 based on control data set 110-1. The user scans code 108-1 and control data set 110-1 is automatically downloaded to user network device 114. Controllable devices 120 connected to user network device 114 are then automatically controlled based on control data set 110-1.

Codes 108 may be placed in different locations, including a store, a kiosk, in a magazine, in broadcast media, and online on different websites. When a user sees a control data set 110 that is desirable, user can scan a code 108 that is associated with control data set 110. The control data set is then automatically configured in the user's home network to control the user's own controllable devices 120.

In one example, a company, such as a store, may offer the control data sets 110 for sale. For example, the store may display various controllable devices 208 that are configured based on the control data sets 110. When users browse through the store, they can choose to purchase control data sets 110 that are of interest. For example, during the holidays, lights may be configured in a policy associated with the holidays. The user may then scan a code 108 to have this policy downloaded to the user's home network to control lights on the user's own network. Thus, a user does not need to manually program the user's own lights. The store may offer complex rules, logic, or policies that may be hard for a user to program. Thus, users may save time by automatically purchasing control data sets 110.

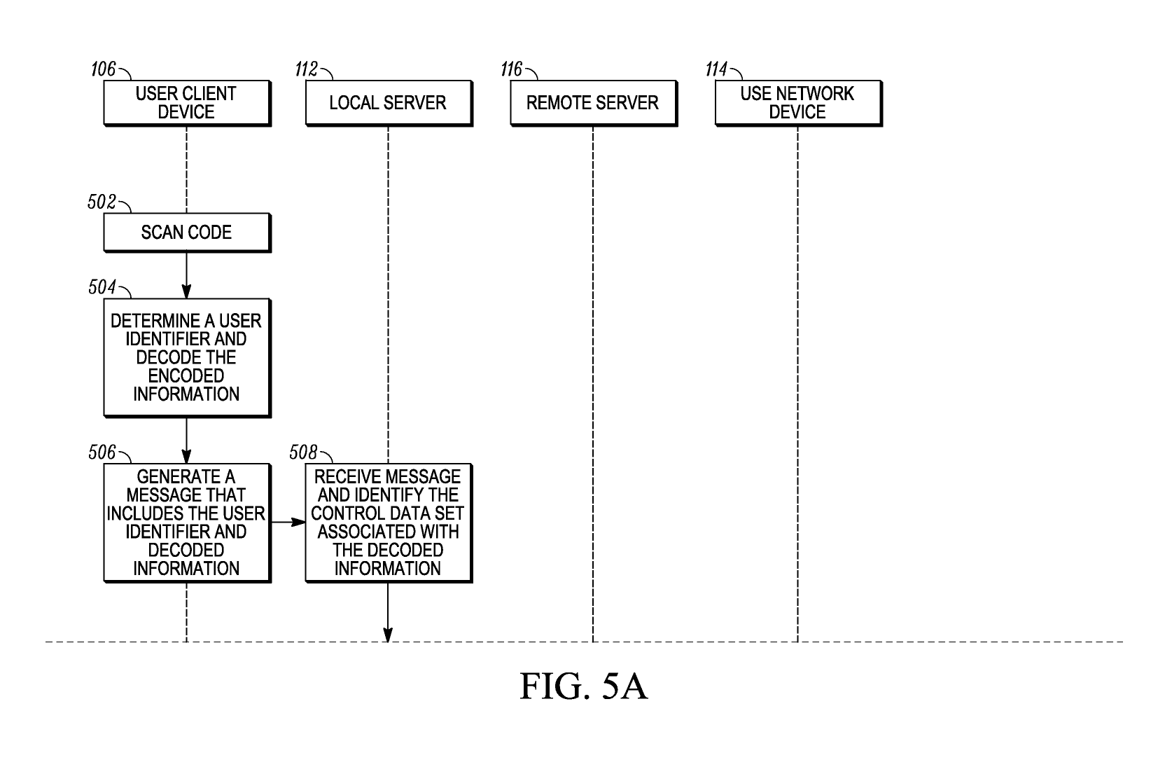

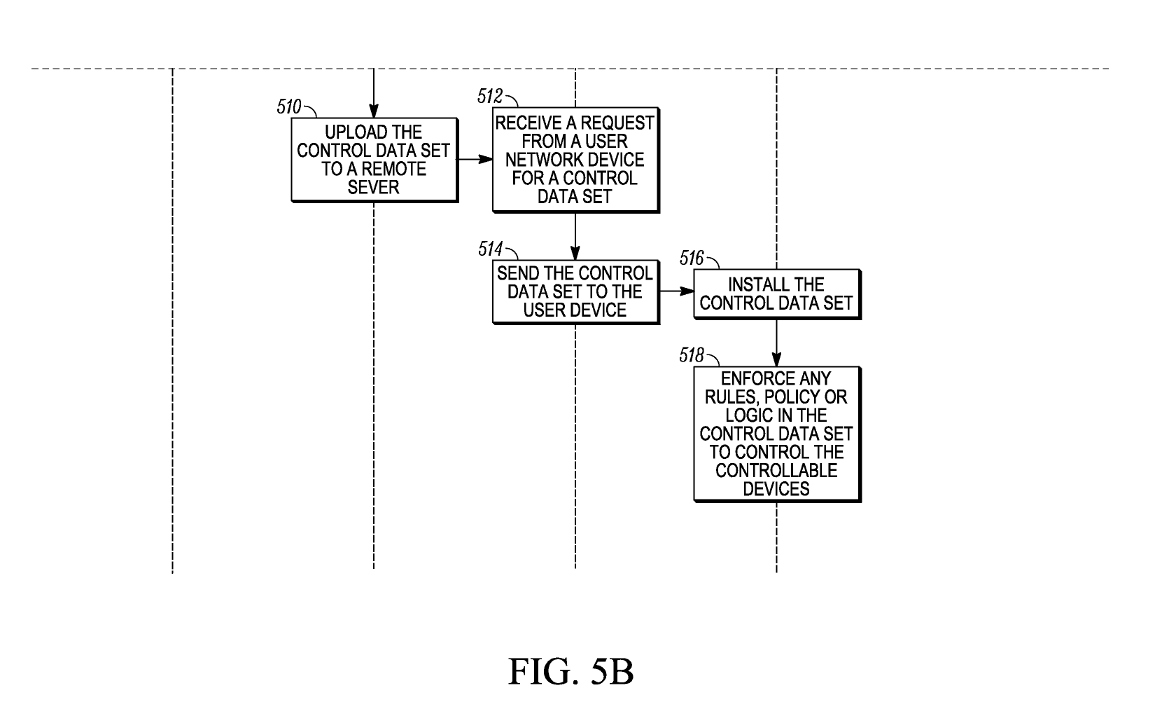

FIGS. 5A and 5B depict a simplified flowchart 500 of a method for automatically configuring controllable devices 120 according to one embodiment. At 502, user client device 102 scans code 108. At 504, user client device 102 determines a user identifier and decodes the encoded information in code 108. Then, at 506, user client device 102 generates and sends a message to local server that includes the decoded information and the user identifier.

At 508, local server 112 receives message and identifies control data set 110 that is associated with the decoded information. At 510, local server 112 then uploads control data set 110 to a remote server 116. In this way, control data set 110 is made available to user network device 114.

At 512, remote server 116 receives a request from user network device 114 for any new control data sets 110. At 514, remote server 116 sends control data set 110 to user network device 114.

At 516, user network device 114 installs control data set 110. Then, at 518, user network device 114 enforces any rules, policies, or logic to control controllable devices 120 connected to user network device 114.

Use of Loyalty Program to Automatically Configure Controllable Devices

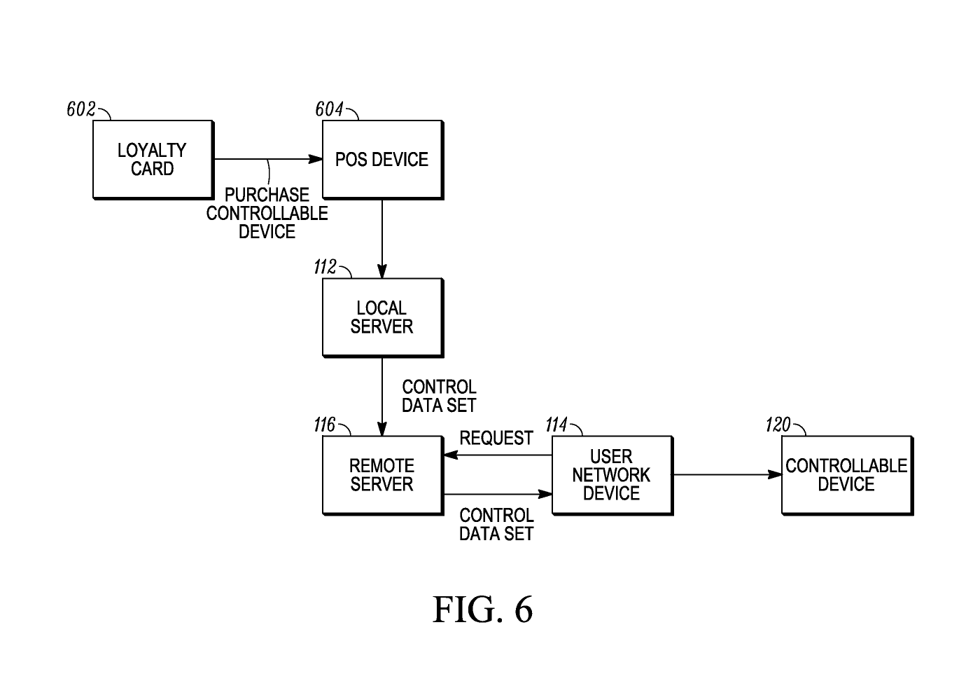

FIG. 6 depicts an example of a system 600 for using a loyalty program to automatically configure controllable devices 120 according to one embodiment. A loyalty program may be linked to a user identifier. For example, a user may sign up for a loyalty program and be issued a loyalty card 602 that includes the user identifier for the user. The user may then use loyalty card 602 when purchasing control data sets 110 and/or controllable devices 120.

In one example, a point-of-sale (POS) device 604 is configured to communicate with loyalty card 602 to determine the user identifier. For example, POS device 604 may read the user identifier when the user scans loyalty card 602 through a magnetic strip reader. In other embodiments, POS device 604 uses NFC or any other contactless technology to determine the user identifier.

Upon determining the user identifier, POS device 604 may provide a control data set 110 to remote server 116. For example, POS device 604 may communicate with local server 112 to have control data set 110 uploaded to remote server 116.

In one embodiment, a user wants to purchase controllable device 120. In this case, a customer representative may scan a product identifier for controllable device 120, or indicate that controllable device 120 is being purchased. Upon identifying controllable device 120 and the user identifier from loyalty card 602, POS device 604 identifies a control data set 110 associated with controllable device 120. POS device 604 can then make control data set 110 available to the user using the user identifier.

As discussed above, user network device 114 can then download control data set 110 and install control data set 110. Thus, when a user connects controllable device 120 to user network device 114, user network device 114 can automatically control controllable device 120 using control data set 110.

Accordingly, a user may use a loyalty program when purchasing controllable devices 120 to have control data sets 110 automatically downloaded to user network devices 114. Thus, users do not need to manually configure controllable devices 120.

Particular embodiments may be implemented in a non-transitory computer-readable storage medium for use by or in connection with the instruction execution system, apparatus, system, or machine. The computer-readable storage medium contains instructions for controlling a computer system to perform a method described by particular embodiments. The computer system may include one or more computing devices. The instructions, when executed by one or more computer processors, may be operable to perform that which is described in particular embodiments.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The above description illustrates various embodiments along with examples of how aspects of particular embodiments may be implemented. The above examples and embodiments should not be deemed to be the only embodiments, and are presented to illustrate the flexibility and advantages of particular embodiments as defined by the following claims. Based on the above disclosure and the following claims, other arrangements, embodiments, implementations and equivalents may be employed without departing from the scope hereof as defined by the claims.

What is claimed is:

1. A method comprising:
receiving a message from a user client device associated with a user, wherein the message is generated in response to a code being captured by the user client device;
determining, by a computer system, a user identifier for a user associated with the user client device based on the message;
determining, by the computer system, a control data set based on the message, the control data set including information used to automatically control a set of controllable devices; and
automatically, by the computer system, making the control data set available to allow access by a user network device associated with the user identifier, wherein the user network device is configured to download the control data set to automatically allow controlling of the set of controllable devices when connected to the user network device.

2. The method of claim 1, wherein the control data set is stored in a storage device and associated with a control data set identifier, the method further comprising:
determining the control data set identifier from the message; and
retrieving the control data set from the storage device using the control data set identifier.

3. The method of claim 1, further comprising receiving the control data set in the message.

4. The method of claim 1, wherein automatically making the control data set available to allow access by the user network device comprises uploading the control data set to a remote server in communication with the user network device.

5. The method of claim 4, wherein the remote server receives a request for the control data set and sends the control data set to the user network device in response to the request.

6. The method of claim 1, further comprising:
generating the code based on a control data set identifier or the control data set; and
outputting the code for capture by the user client device.

7. The method of claim 6, wherein generating the code comprises encoding the control data set identifier or the control data set into the code.

8. The method of claim 1, wherein the code comprises a graphical representation or an electronic code.

9. The method of claim 1, wherein the control data set comprises rules, logic, or policies to control the set of controllable devices.

10. A method comprising:
capturing, by a user client computing device, a code including encoded information for controlling a set of controllable devices;
decoding, by the user client computing device, the encoded information from the code;
determining a user identifier for a user associated with the user client computing device;
generating, by the user client computing device, a message using the decoded information and the user identifier; and
sending, by the user client computing device, the message to a server to have a control data set automatically made available to allow access by a user network device associated with the user identifier, wherein the user network device is configured to download the control data set to automatically allow controlling of the set of controllable devices when connected to the user network device.

11. The method of claim 10, wherein decoding the code comprises determining a control data set identifier or the control data set from the encoded information, the method further comprising:
including the control data set identifier or the control data set in the message.

12. The method of claim 10, further comprising:
receiving the user identifier at an application; and
generating the message to include the user identifier using the application.

13. The method of claim 10, wherein the code comprises a graphical representation or an electronic code.

14. The method of claim 10, wherein the code is displayed on a medium.

15. The method of claim 10, wherein the code is stored in a computing device for transmission to the user client computing device.

16. A system comprising:
a user client computing device configured to:
capture a code including encoded information for controlling a set of controllable devices;
decode the encoded information from the code;
determine a user identifier for a user associated with the user client computing device;
generate a message using the decoded information and the user identifier; and
send the message;
a server configured to:
store a control data set in association with the user identifier in response to the message;
make the control data set automatically available to allow access by a user network device associated with the user identifier in response to the message being sent; and
send the control data set to the user network device,
wherein the user network device installs the control data set to automatically allow control of the set of controllable devices when connected to the user network device.

17. The system of claim 16, wherein:
the user client device comprises a mobile device, and
the server is connected to the user network device via a wide area network.

18. The system of claim 16, wherein the server comprises:
a local server configured to receive the message and determine the control data set; and
a remote server configured to receive the control data set from the local server and make the control data set available to the user network device.

19. The system of claim 16, wherein the user network device is configured to apply logic, rules, or policies for the control data set to the set of controllable devices.

20. The system of claim 16, wherein the user network device is configured to:
receive an event for a controllable device in the set of controllable devices,
apply the event to the control data set, and
determine an action to perform based on applying the event to the control data set.
